(19) United States
(12) Patent Application Publication
(10) Pub. No.: US 2026/0141323 A1
(43) Pub. Date: May 21, 2026

(54) Computing System And Method For Generating Intelligent Construction Project Schedules

(71) Applicant: Procore Technologies, Inc., Carpinteria, CA (US)

(72) Inventors: Julian Clayton, Milford, CT (US); Hemendra Pal, Round Rock, TX (US)

(21) Appl. No.: 18/952,795

(22) Filed: Nov. 19, 2024

(51) Int. Cl. G06Q 10/0631; G06Q 50/08

(52) U.S. Cl. CPC G06Q 10/06312; G06Q 10/063118; G06Q 50/08

(57) ABSTRACT

A computing platform is configured to (i) receive input data indicating a set of tasks to be performed for a construction project, (ii) generate a task data object for each task including an association with a reference data object that must be complete before the task can start, a record data object that must be complete before the task can be completed, and a physical location within the construction project where the task will be performed, (iv) receive two or more candidate schedule adjustments, each candidate schedule adjustment pulling a subset of task data objects forward in time on a master schedule, (v) identify a schedule conflict between task data objects in the candidate schedule adjustments, (vii) generate an updated candidate schedule adjustment that eliminates the schedule conflict, and (viii) update the master schedule to pull forward one or more task data objects according to the updated candidate schedule adjustment.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### Overview

Disclosed herein is new software technology for generating and utilizing an intelligent construction project schedule that encodes the connectivity between numerous different types of schedule-related data objects stored across a construction management software application.

In one aspect, the disclosed technology may take the form of a method that involves (i) receiving input data indicating a set of tasks to be performed for a construction project, (ii) for each task in the set of tasks (a) identifying one or more reference data objects that must be complete before the task can start, one or more record data objects that must be complete before the task can be completed, and one or more physical locations within the construction project where the task will be performed, and (b) generating a task data object including an association with each of the one or more reference data objects, the one or more record data objects, and the one or more physical locations, (iii) maintaining a master schedule for the construction project comprising each of the generated task data objects, (iv) receiving two or more candidate schedule adjustments to the master schedule, wherein each candidate schedule adjustment comprises pulling a subset of task data objects corresponding to a respective trade forward in time on the master schedule, (v) identifying one or more schedule conflicts between respective task data objects in two or more of the candidate schedule adjustments, wherein the one or more schedule conflicts are based on one or more respective reference data objects, record data objects, or physical locations associated with the respective task data objects (vi) generating at least one updated candidate schedule adjustment for at least one of the respective trades that eliminates the one or more schedule conflicts, and (vii) updating the master schedule to pull forward one or more task data objects according to the updated candidate schedule adjustment.

In some examples, receiving two or more candidate schedule adjustments to the master schedule may involve receiving, from a first client station associated with a first user, a first candidate schedule update corresponding to a first trade and receiving, from a second client station associated with a second user, a second candidate schedule update corresponding to a second trade.

Still further, in some examples, generating a task data object including an association with each of the one or more reference data objects, the one or more record data objects, and the one or more physical locations may involve generating an initial task data record and after generating the initial task data record, updating the initial task data record to include the association with each of the one or more reference data objects, the one or more record data objects, and the one or more physical locations.

Still further, in some examples, the method may involve, after generating each task data object including an association with each of the one or more reference data objects, the one or more record data objects, and the one or more physical locations, adding the generated task data object to the master schedule.

Still further, in some examples, the method may involve determining, for a given task, that a given reference data object associated with the given task is incomplete and based on determining that the given reference data object is incomplete, causing a visual indication of the incomplete reference data object to be displayed on a representation of the master schedule.

Still further, in some examples, the method may involve merging the two or more candidate schedule adjustments to the master schedule into a merged draft schedule.

Still further, in some examples, a first task data object and a second task data object have a dependency relationship in the master schedule, and identifying one or more schedule conflicts between respective task data objects may involve determining that the dependency relationship is violated by at least one of the candidate schedule adjustments.

Still further, in some examples, identifying one or more schedule conflicts between respective task data objects may involve determining that at at least one of the candidate schedule adjustments includes pulling forward a task data object associated with a given physical location to a given time period, where a different task data object associated with the given physical location is also scheduled for the given time period.

In another aspect, the disclosed technology may take the form of a computing platform comprising at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium comprising program instructions stored thereon that are executable to cause a computing platform to carry out the functions of the aforementioned method.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts an example network environment in which a construction management software application may be implemented, according to the present disclosure.

FIG. 2A depicts an example view of a master schedule for a construction project, according to the present disclosure.

FIG. 2B depicts an example view of a task data object within a scheduling tool, according to the present disclosure.

FIG. 3 depicts an example flow chart showing functionality that may be carried out to generate an intelligent construction project schedule software, according to the present disclosure.

FIG. 4 depicts a simplified block diagram of a computing platform and an example data flow pipeline for generating an intelligent construction project schedule, according to the present disclosure.

FIG. 5 depicts an example view of a master schedule for a construction project.

FIG. 6 depicts an example flow chart showing functionality that may be carried out to collaboratively update a construction project schedule, according to the present disclosure.

FIG. 7 depicts a simplified block diagram of a computing platform and an example data flow pipeline for collaboratively updating a construction project schedule, according to the present disclosure.

FIG. 8 is a simplified block diagram that illustrates some structural components that may be included in an example computing platform, according to the present disclosure.

FIG. 9 is a simplified block diagram that illustrates some structural components that may be included in an example client device, according to the present disclosure.

### DETAILED DESCRIPTION

The following disclosure refers to the accompanying figures and several examples. A person of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

Construction management today is often performed through the use of software applications, such as the software application provided by Procore Technologies, Inc.® (“Procore,” which is the applicant of the present disclosure). These software applications generally provide users the ability to create, store, view, and/or interact with various types of data related to a construction project, such as specifications, drawings, building information model (BIM) files, requests for information (RFIs), risk management plans, safety plans, work breakdown structures, change orders, inspection documents (e.g., which record information about the results of inspections), punch lists (e.g., which list work that has not yet been completed or has been completed incorrectly), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project, etc.), directories, invoices, timesheets, meeting minutes, sensor data, and daily logs (e.g., which record information about each day work is done at a work site of the construction project), among many other examples of project data that may be stored for a construction project.

In practice, these construction management software applications may take various forms. As one possible implementation, a construction management software application may include both front-end client software running on client devices that are accessible to individuals associated with construction projects (e.g., contractors, project managers, architects, engineers, designers, etc.) and back-end software running on a back-end platform (sometimes referred to as a “cloud” platform) that interacts with and/or drives the front-end software, and which may be operated (either directly or indirectly) by the provider of the front-end client software. This form of a software application may be referred to as a client-server application or a software-as-a-service (SaaS) application, among other possibilities. As another possible implementation, a construction management software application may include front-end client software that runs on client devices without interaction with a back-end platform. These software applications may take other forms as well.

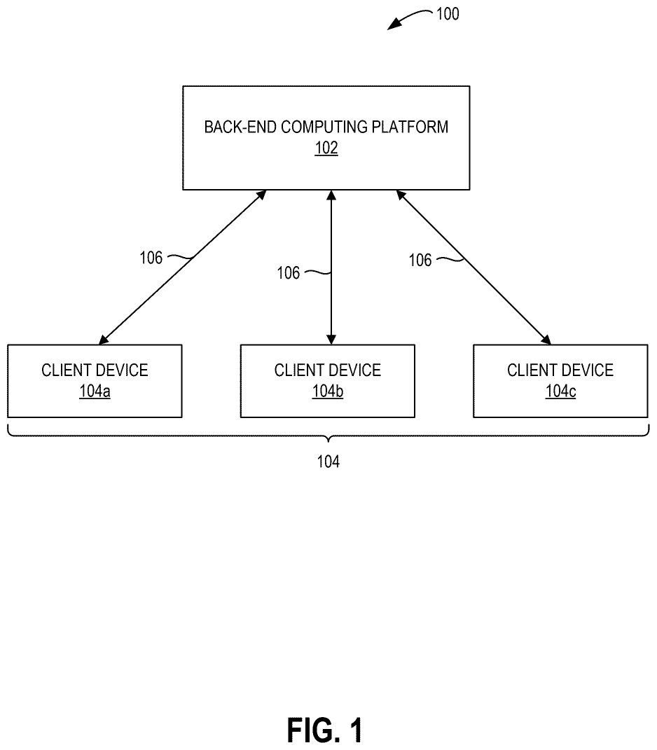

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which include the client device 104a, the client device 104b, and the client device 104c. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of the back-end computing platform 102 may collectively comprise some set of physical computing resources (e.g., one or more processors, data storage systems, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106. In this respect, each of the communication paths 106 between the back-end computing platform 102 and one of the client devices 104 may generally comprise one or more communication networks and/or communications links, which may take any of various forms. For instance, each of the respective communication paths 106 with the back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each of the respective communication paths 106 with the back-end computing platform 102 may be wireless, wired, or some combination thereof, and may carry data according to any of various different communication protocols. Further yet, communications over each of the respective communication paths 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). Many other environments are also possible.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in which a construction management software application may be implemented. Numerous other arrangements are possible and contemplated herein. For instance, other network configurations may include additional components not pictured and/or more or fewer of the pictured components.

In line with the discussion above, construction management software applications may enable users to manage construction projects electronically, which may involve software features for creating, storing, viewing, and/or interacting with various types of data that may be stored as objects of various forms (e.g., specifications, drawings, BIM files, RFIs, schedules punch lists, directories, invoices, timesheets, meeting minutes, daily logs, etc.). Further, in at least some implementations, the software features for creating, storing, viewing, and/or interacting with the various types of data objects may optionally be arranged into different software “tools” that each correspond to a different type (or category) of data object. For instance, a construction management software application may include an “RFIs” tool for creating, storing, viewing, and/or interacting with RFI data objects, a “Daily Log” tool for creating, storing, viewing, and/or interacting with Daily Log data objects, and so on. However, in other implementations, the software features for creating, storing, viewing, and/or interacting with the various types of data objects may be arranged in other manners that are not based on software tools paradigm.

In operation, existing construction management software applications may enable a representative of a given party (e.g., a general contractor) to (i) create an account with a construction management software application and (ii) add a set of individuals associated with the given party as users on the given party's account. After the given party's account is created and a set of users have been added, the construction management software application may thereafter enable the representative of the given party (or some other representative that has been added to the account as a user having the requisite permissions) to (i) create a respective project workspace for each of one or more construction projects that involve the given party and (ii) for each such construction project, designate a respective subset of the given party's users that are allowed to access data associated with the respective project workspace. In this respect, the given party may be considered to be the “owner” of the project workspace(s) and the data contained therein.

In line with the discussion above, one of the many construction management activities that a construction management software application may be used for is project scheduling. In this regard, a schedule for a construction project is typically created based on a breakdown of all of the work that needs to be performed to complete the project. A breakdown of this kind is generally referred to as a work breakdown structure, or WBS, which presents an outline of project deliverables that are organized by levels into a hierarchy of activities, tasks, sub-tasks, and so on. For example, a WBS for a construction project may include a breakdown of activities and tasks that are organized by activity codes that generally correspond to different trades (e.g., concrete, masonry, carpentry, electrical, plumbing, etc.). Further, a WBS may include an indication of the resources that may be required to complete each activity, including labor, materials, equipment, and so on.

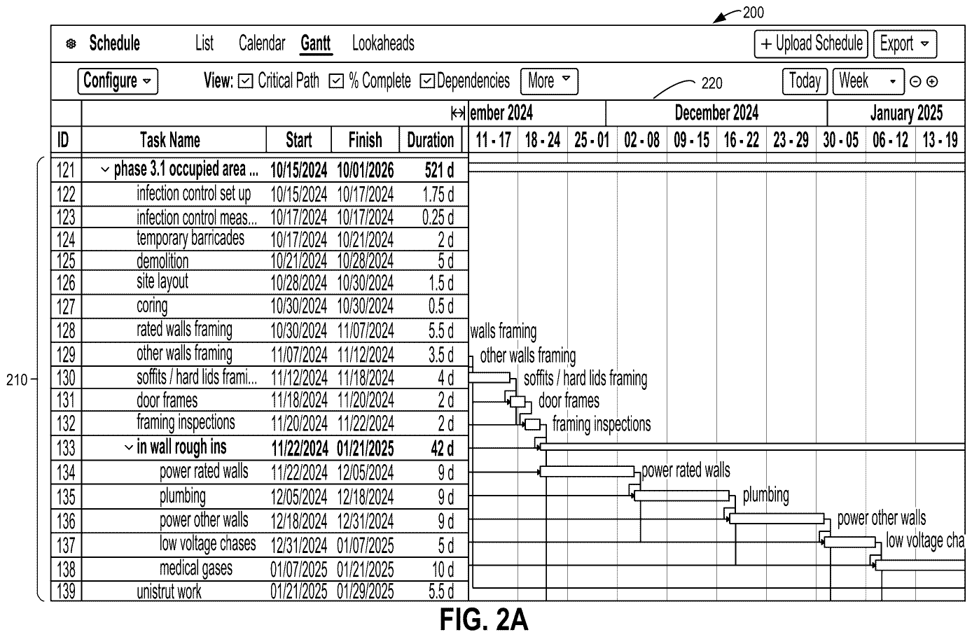

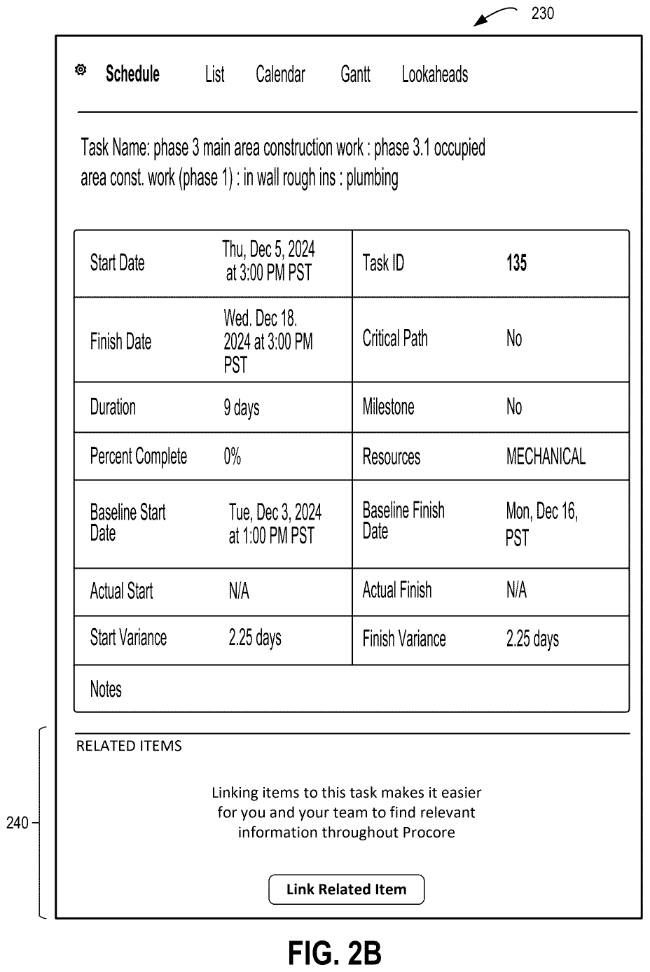

In turn, a project schedule may be created by arranging the activities and tasks from all levels of the WBS into a bar chart or similar visual representation that displays the information in chronological order along a horizontal axis. In this way, the construction schedule may display planned start and finish dates for activities and tasks, dependencies between activities and tasks (e.g., which tasks must be completed before a given task can begin), and the critical path for the construction project (e.g., the longest sequence of dependent tasks that must be finished to complete the project). One common representation of a construction project schedule is known as a Gantt chart, although a construction schedule can be displayed in various other ways as well. One possible example of a Gantt chart can be seen in FIG. 2A, which depicts a snapshot 200 of a “Schedule” tool of a construction management software application.

As shown in FIG. 2A, the example Gantt chart includes a schedule-item listing 210 for a given construction project, which comprises line items representing respective activity and task data objects that have been created and stored for the given construction project. The Gantt chart also includes a calendar 220 that uses horizontal bars to indicate respective date ranges for the schedule-item data objects indicated by the line items in the schedule-item listing 210. The respective date range for a schedule-item data object may indicate one or more days in which a schedule task represented by the schedule-item data object is expected to be carried out. In addition, the Gantt chart illustrates dependencies between the schedule-item data objects via connections between the blocks.

In this regard, the construction management software application may help users organize and plan a construction project on both a macro and a micro level. At the macro level, a construction management software application may maintain a master schedule for the construction project that includes a representation of all of the activities and tasks that must be performed to complete the construction project and an indication of milestone dates by which certain activities and tasks are expected to be completed. At the micro level, users may generate lookahead schedules that represent a zoomed-in view of the master schedule within a particular timeframe, such as the next two, three, or four weeks, among other possibilities. Based on the lookahead schedule, a user can plan specific, day-to-day or week-to-week schedules on an ongoing basis with lookahead plans, e.g., every two weeks.

Despite the usefulness of scheduling tools provided in current construction management software applications, there are still various associated drawbacks. In particular, the information that is used to generate a construction project schedule within a construction management software application (e.g., WBS data) is generally limited to the information that can establish the interdependency between schedule activities and tasks and their respective start and finish dates, and perhaps the resources required. However, various other types of information that are unrelated to the WBS, and which are created within other tools of a typical construction management software application, can have a direct impact on a construction project's schedule.

For example, before a given activity or task in a construction project schedule can be carried out, various other items must be created first. As some examples, a set of drawings must be prepared by an architect or engineer, a material submittal must be submitted by a subcontractor and approved by the general contractor, and so on. Accordingly, delays in the completion of any of these items can affect the scheduled activity or task, yet these items are not created in nor tracked by a Schedule tool. Similarly, many activities or tasks in a construction project require inspections or other close out items that must be provided by a party other than the one that completes the work associated with the activity or task. This can similarly lead to difficulties with coordination when dates are updated.

In many instances, a Schedule tool may be provided as standalone software that does not even intake much of the related construction data that can have a direct impact on the schedule. Moreover, even when a Schedule tool is included within a construction management software application that includes information for these other types of items, the data objects created within the Schedule tool generally do not have any defined relationship, at a logical level within the construction management software application, to the other information within the construction management software application, such as drawings, documents, submittals, resources, inspections, etc. that may affect, or be affected by, the schedule.

In some existing applications, it may be possible to link a document or other data object to a scheduled task within the Schedule tool, if a user decides that they are related. FIG. 2B provides a snapshot 230 of an example GUI that allows a user to link an item to a schedule task via a “Related Items” pane 240. For instance, a user might decide to link a submittal data object, created within a Submittals tool of the construction management software application, to the scheduled task because the submittal in question must be approved before the scheduled task can start.

However, the linking of related items shown in FIG. 2B is informational only, and only results in a shortcut or similar ability to view the linked submittal if a user were to click on it within the schedule task. It does not create a logical relationship between the schedule task and the submittal, nor any other data object that might be linked to the task. As a result, the functionality of current construction management software applications is lacking in its ability interrelate schedule information with other, non-schedule information within a construction management software application that nonetheless may have an impact on the schedule.

For example, referring again to the example shown in FIG. 2B, any changes (e.g., date changes) to the construction schedule that should affect the linked item (e.g., a linked submittal item) in practice do not have any effect on the linked item within the construction management software application. Rather, a user must recognize the effects of any such schedule changes and manually update the linked item. Similarly, a change to a linked item (e.g., a date change) that has a practical effect on the scheduled task has no effect on the scheduled task within the construction management software application. Instead, the change to the linked item and its effect on the scheduled task might not be appreciated until a problem occurs. Moreover, the consequences of any proposed change to the schedule may be difficult to assess due to this lack of connectivity, as the downstream impacts to non-schedule items may not be clear and/or may impact other items or stakeholders that are seemingly unrelated to the reason for the proposed change.

Many other examples of problems that result from a lack of integration between schedule-related data are possible. Such problems may cause a construction management software application to be inefficient at the planning and management tasks for which they are used.

To address these and other problems with existing construction management software applications, disclosed herein is new technology for generating an intelligent construction project schedule that facilitates the interconnection of numerous different types of schedule-related data objects stored across a construction management software application. The new technology disclosed herein may present users with a more effective way to relate construction project data directly to the construction project's schedule, which in turn can lead to improved planning, fewer schedule conflicts and coordination issues, among other beneficial outcomes.

At a high level, the disclosed technology may involve generating activity and task data records for a construction schedule that include new logical links to various data objects within the construction management software application that have never been intelligently linked to the schedule before. The types of data objects that may be logically linked to the activity and task data objects of the construction schedule may be created and maintained in other tools of the construction management software application, as discussed in further detail below.

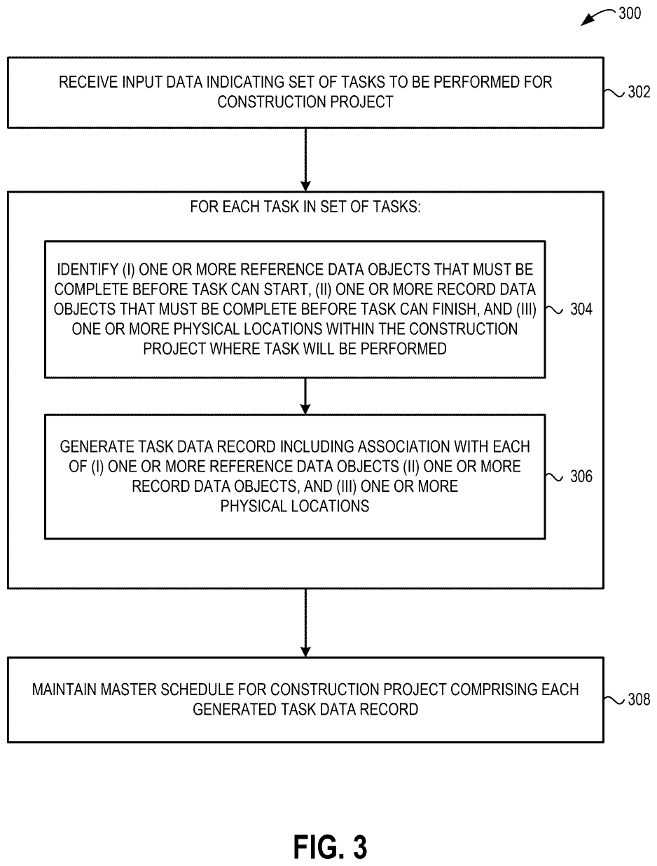

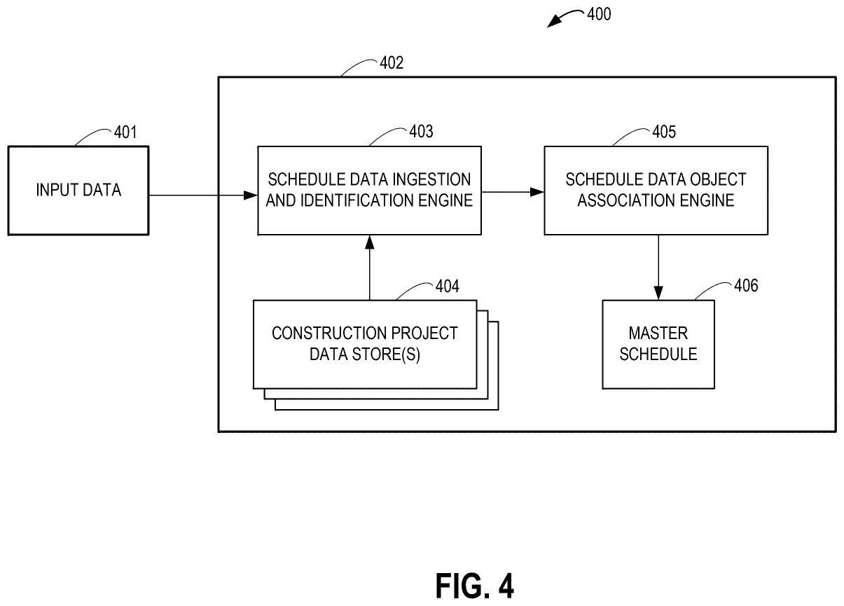

Turning to FIG. 3, example functionality is illustrated in the form of a flow diagram 300 illustrating operations that may be carried out to generate a construction schedule. The example operations will be discussed with reference to FIG. 4, which depicts a simplified block diagram of an example data flow pipeline 400 involving a computing platform 402 that is hosting a construction management software application. In this regard, the computing platform 402 may be similar to, or the same as, the back-end computing platform 102 of FIG. 1. However, the example functionality of FIG. 3 may be carried out by any computing platform that is capable of running the software disclosed herein. Further, it should be understood that the example functionality of FIG. 3 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 3, the example operations may begin at block 302 with the back-end computing platform 402 receiving input data that indicates a set of activities and tasks to be performed for a construction project, shown visually as the input data 401 in FIG. 4. In this regard, the input data 401 indicating the set of activities and tasks may be received from one or more client devices, such as the client devices 104 shown in FIG. 1. Alternatively, the input data 401 may be received from one or more other back-end computing platforms associated with a separate construction management software application. The input data 401 might also be received form combinations of the above, among other possibilities.

The input data 401 indicating the set of activities and tasks may take various forms. As one example, the input data 401 may take the form of activity and task data that is provided to the computing platform 402 during the initial creation of a WBS using the construction management software application hosted by the computing platform 402. In this regard, the input data 401 may include information defining various activities, which may be broken down into smaller units at different levels of a WBS until individual tasks are defined. The input data 401 may include the baseline information that establishes the duration of each activity and task, and further establishes the sequence-based dependencies that dictate the order in which the activities and tasks must be performed. Based on the input data 401, the computing platform 402 may generate a WBS (e.g., using a “WBS” tool of the construction management software application) as part of the construction project planning process.

As another example, the input data 401 may take the form of WBS data for a WBS that was previously created using a separate construction management software application operating on a separate computing platform. For instance, the separately-created WBS may be imported to the construction management software application that is running on the computing platform 402. Importing the WBS data in this way may involve mapping the imported WBS data to the native WBS tool within the construction management software application running on the computing platform 402. For example, the imported WBS data may include numerous WBS data segments that correspond to the activities and tasks defined in the imported WBS data. Accordingly, each of these data segments may be mapped to a corresponding data segment in the native WBS tool of the construction management software application operating on the computing platform 402.

As another possibility, the input data 401 may include a combination of the different types of input data 401 discussed above. For example, the computing platform 402 may receive input data 401 in the form of an imported WBS that was created using another construction management software application. After mapping the imported WBS data to the native WBS tool of the construction management software application operating on the computing platform 402, or as a part of the mapping process, the input data 401 may further include manually input data indicating activities and tasks that is used to append the imported WBS data. The reverse may also be possible—e.g., input data 401 that is received by the computing platform 402 to generate a WBS may be appended, without duplicating information, using the imported WBS data from other construction management software applications.

The input data 401 may take various other forms as well.

The computing platform 402 may receive the input data 401 and process it using a schedule data ingestion and identification engine 403, as shown in FIG. 4. In this regard, schedule data ingestion and identification engine 403 may take various forms, including one or more data ingestion and processing tools (e.g., operating as one or more subsystems of the computing platform 402), some or all of which may operate to process and prepare the incoming input data 401 for use by other components of the computing platform 402. For input data 401 that takes the form of imported WBS data from another construction management software application, the schedule data ingestion and identification engine 403 may carry out the operations of importing the data and mapping the imported WBS data segments to the WBS data segments of the native WBS tool. Various other implementations are also possible.

At block 304, the computing platform 402 may identify, for each activity or task indicated in the set of activities and tasks that was received as input data 401, various data objects within the construction management software application that may have a direct effect on the scheduling of the activity or task, but which have traditionally not been associated with a construction project schedule within a construction management software application in any consequential way. The schedule data ingestion and identification engine 403 of the computing platform 402 may carry out the identification at block 304 in various ways, which may involve accessing other data stored within the construction management software application. In this regard, FIG. 4 illustrates a set of data stores 404 that may store information related to data objects and project information that are created within the construction management software application. The schedule data ingestion and identification engine 403 may include one or more artificial intelligence (AI) models that are configured to carry out one or more searches of the data stores 404 to identify data objects that are related to each schedule item received in the input data 401. For example, the AI model(s) included in the schedule data ingestion and identification engine 403 may carry out one or more keyword searches, full-text searches, and/or semantic searches, among other types of searches, to identify data objects that are related to each schedule item received in the input data 401. Several examples of the types of data objects and information that may be identified at block 304 are discussed below.

At block 306, the computing platform 402 may generate, for each activity or task included in the input data 401, a respective activity or task data object that includes such an association (e.g., a logical link) with the one or more data objects that were identified, at block 304, for each respective activity or task. In this regard, each activity data object or task data object that is generated in this way may include attributes corresponding to the types of information that are typically included in the data objects that make up a construction schedule, such as start and finish dates, dependencies with other activities or tasks, and the like. Importantly, however, the activity and task data objects discussed herein also include the associations with the data objects that were identified at block 304. In particular, the computing platform 402 may include a schedule data object association engine 405, shown in FIG. 4, that generates an association between the activity or task data object and its related data objects.

The type of association that the schedule data object association engine 405 generates may take various forms, depending on the type of data object that was identified at block 304. At a high level, the association may take the form of a logical link or reference to the identified data object. As a result of the logical link, one or more attributes of the identified object (e.g., a completion status, a relevant date, etc.) and any changes in such attributes may have dynamic effects on corresponding attributes of the associated activity or task data object, and vice versa. For instance, a schedule update that results in a change to an attribute of a given activity or task data object may cause a corresponding change to be dynamically applied to any linked data objects that are not themselves a part of the schedule, but are nonetheless affected in a secondary way by schedule changes.

Each of the activity or task data objects that are generated by the computing platform 402 at block 306 may be added to a master schedule for the construction project, as shown in FIG. 4 as the master schedule 406. In this regard, the master schedule 406 may be a collective data object that includes each of the generated activity and task data objects and all of the respective associations that were identified as discussed above. In turn, at block 308, the computing platform 402 may maintain the master schedule 406 (e.g., within a Schedule tool of the construction management software application), which may include associations (e.g., logical links) with numerous other data objects that are created and maintained within other tools of the construction management software application.

Various different types of data objects within a construction management software application that may be identified, for a given activity or task indicated in the input data 401, using the schedule data ingestion and identification engine 403 will now be described in connection with the corresponding logical links that may be generated by the schedule data object association engine 405.

As one example, the computing platform 402 may identify one or more reference data objects that are related to the given activity or task that is included in the input data 401. Reference data objects, or simply “references,” are data objects that support the scope of work of an activity or task and are generally required to be completed before an activity or task can start. Reference data objects may take various forms including drawings (e.g., architectural or engineering drawings), documents (e.g., an installation specification), and submittals (e.g., a list of materials submitted by a contractor for approval), among numerous other possibilities. Each of these types of reference data objects may normally be handled by a different tool of the construction management software application, such as a “Drawings” tool, a “Document Management” tool, and a “Submittals” tool, respectively. Further, each of these types of reference data objects may include a status attribute within the construction management software application that has a value indicating its current status, such as “pending” or “completed.” In some situations, a reference data object (e.g., a document) might take the form of a placeholder data object with a status of “placeholder” indicating that the underlying data object does not exist yet, but it is expected to. Eventually, the placeholder data object may be replaced by the expected reference data object, and its status may be updated. Other statuses are also possible.

Reference data objects that are associated with an activity or task may serve as logical constraints to starting the activity or task. If a task has an associated reference data object that is in a pending or placeholder state, it may constrain the task from being started. For instance, when a user of a client station (e.g., one of the client stations 104) accesses the Schedule tool of the construction management software application and views a graphical representation of the master schedule (e.g., the user views a 3-week lookahead schedule corresponding to work for which they are responsible), the scheduled task may be displayed in a specific color or with an associated alert that indicates that the task cannot start due to an incomplete reference data object. In some embodiments, the construction management software application may enforce a period of time (e.g., one week) ahead of an activity or task's scheduled start date by which the reference data object must be complete in order for the activity or task to start.

The constraints imposed by an associated reference data object may also be applied to other dependent activities and tasks. For example, if a schedule activity, such as “in wall rough ins” shown in FIG. 2A, that includes several child tasks is constrained by an incomplete reference data object (e.g., a set of mechanical, electrical, and plumbing (MEP) drawings), each of the child tasks will also be constrained. On the other hand, if a given child task, such as “plumbing” shown in FIG. 2A, is constrained by a task-specific reference data object (e.g., a pipe joint specification submitted by a plumbing subcontractor), other tasks within the same activity might not be similarly constrained. For example, the task “power rated walls” precedes “plumbing” in the master schedule and may start even though “plumbing” is constrained by its incomplete reference data object.

It will be appreciated from the example above that the reference data object association with the “plumbing” task results in a master schedule that is able to provide users with better information and an improved ability to plan and manage a construction project over what existing schedule tools can provide. For instance, a GUI view of an existing schedule tool that lacks the additional data object associations discussed herein might indicate that all scheduled activities and tasks that were required to be completed prior to the start of the “in wall rough ins” activity have been completed. Further, the first child task “power rated walls” may have started and may be proceeding normally. Considering traditional schedule data only, the “plumbing” task might be expected to start on time, once the “power rated walls” task is complete, and a GUI view of a traditional schedule tool might indicate this expected result. However, due to oversight, miscommunication, and/or other possible reasons, a document required for the “plumbing” task to start (e.g., a pipe joint specification submitted by a plumbing subcontractor) is still in a pending state, which may not be recognized until it is already causing a delay in the start date of the “plumbing” task and as a result, is also blocking all subsequent tasks. In this way, an existing Schedule tool may have no way of helping users anticipate this issue and resolve it before it becomes a larger problem.

On the other hand, utilizing the improved technology for generating and utilizing an intelligent construction project schedule discussed herein, the computing platform 402 may determine, based on the data object association discussed above, that the reference data object associated with the “plumbing” task is not complete and thus the “plumbing” task cannot start. Based on this determination, the computing platform 402 may cause a user's client device 104 to display a GUI view of the master schedule 406 (e.g., a Gantt chart, a lookahead schedule, etc.) that includes one or more visual indications that the “plumbing” task is currently blocked from starting by something that is not displayed within the master schedule 406 (e.g., something other than a predecessor task or activity). The visual indication may take various forms, including a differently colored bar in the visual bar graph that represents the schedule, a notification or similar alert, among other possibilities.

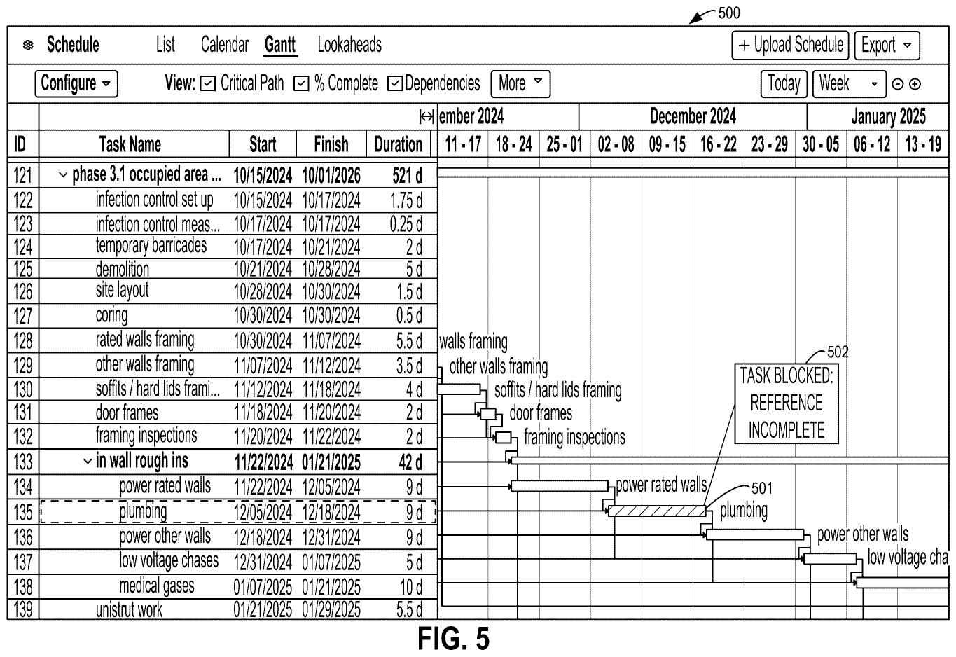

FIG. 5 illustrates an example snapshot 500 of a master schedule that includes two of the visual indications discussed above. In particular, the bar 501 representing the “plumbing” task is displayed differently and a notification 502 is displayed over the Gantt chart indicating that the “plumbing” task is blocked from starting due to an incomplete reference data object that is associated with the task. The visual indication of the potential schedule issue might be displayed in other ways and in other views as well, including other screens within the Schedule tool. In addition, the computing platform 402 may be configured to generate schedule alerts to notify users that the blocked task has the potential to become a problem that will delay the schedule if it is not resolved within a given period of time.

In some embodiments, the associations generated by the schedule data object association engine 405 may enrich not only the activity and task data objects that are maintained in the master schedule 406, but the associated data objects as well. For example, each reference data object that is identified at block 304 (e.g., a drawing, a document, a submittal, etc.) may include a due date attribute that indicates a value for when the data object is required to be completed. When these reference data objects are associated with activity and task data objects by the schedule data object association engine 405 at block 306, the schedule data object association engine 405 may update the value of the reference data object's due date, if necessary, to be before (e.g., a predetermined period of time before) the start date of the associated activity or task. In particular, some of the reference data objects might have been created, within other tools of the construction management software application, without a value for their due date at all. In these situations, the schedule data object association engine 405 may assign a due date to the reference data objects, according to their association with the activity and task data objects in the master schedule 406.

In view of the above, it will be appreciated that changes to an activity or task data object may affect its associated reference data objects. Similarly, a change to a reference data object may affect some or all of the activity or task data objects that are associated with it. Accordingly, the computing platform 402 may cause such updates to a given data record to be dynamically applied to its associated data records. For example, a schedule activity that is pulled forward in time to start sooner than originally scheduled may involve adjusting the start date of the corresponding schedule activity data object within the master schedule 406. This, in turn, may trigger a corresponding update to the due dates of one or more reference data objects that must be completed before the activity can start. In this regard, the due dates of each reference data object may be updated within their own respective tool of the construction management software application, based on the change within the Schedule tool. The computing platform 402 may notify users associated with the updated reference data objects, notifying them of the revised due date. Alternatively, the completion of a reference data object may be delayed, requiring its due date to be pushed back in time. In a similar way, the computing platform 402 may cause this type of update—implemented in a separate tool of the construction management software application—to be propagated to the Schedule tool and the affected activity and task data records that are associated with the delayed reference data object.

Numerous other types of updates that may be dynamically applied across different tools of the construction management software application are also possible, based on the association of various different reference data objects to activity and task data objects within the master schedule.

Another example of a type of data object within a construction management software application that may be identified using the schedule data ingestion and identification engine 403 is a record data object. Record data objects, or simply “records,” are data objects that represent acceptance or completion of a given activity or task and are generally required to be completed before the activity or task can be completed. Record data objects may take various forms including action plans, inspections, observations, photos, among numerous other possibilities. Each of these types of record data objects may normally be handled by a different tool of the construction management software application, such as an “Action Plans” tool, an “Inspections” tool, an “Observations” tool, and a “Photos” tool, respectively. Further, each of these types of record data objects may include a status attribute within the construction management software application that has a value indicating its current status, such as “pending” or “completed.”

Notably, a record data object does not itself correspond to the work associated with a given activity or task being completed. For this reason, all of the work associated with a given activity or task may be completed, but the task's status may not be able to be updated to “complete” because a required record data object is not complete. For instance, referring again to the “plumbing” task shown in FIG. 2A, all of the pipes and plumbing fixtures shown in the plumbing drawings may be installed and the physical plumbing work may be complete. However, the project specification may dictate that a plumbing inspector needs to submit and mark as complete (or approved, closed, etc.) an inspection data record corresponding to a plumbing inspection. In this way, record data objects may serve as logical constraints to completing an activity or task. When a user of a client station (e.g., one of the client stations 104) accesses the Schedule tool of the construction management software application and views a graphical representation of the master schedule (e.g., the user views a 3-week lookahead schedule corresponding to work for which they are responsible), the plumbing task may be displayed in a specific color or with an associated alert that indicates that the work for the task is complete, but that one or more record data objects are outstanding.

In some implementations, a given task may have multiple associated record data objects. For example, the “plumbing” task may require both the inspection mentioned above as well as one or more photos documenting the plumbing installation. In these situations, the combined status of all associated record data objects for a given task, across various different tools of the construction management software application, may represent the status of the task. Thus, if the record data object for the inspection is complete but the record data object for the photos is not complete, then the status of the plumbing task data record within master schedule 406 is also not complete, and it cannot be marked as complete until all record data objects are completed first. Similarly, if all record data objects are marked as complete within their respective tools of the construction management software application, the computing platform 402 may, based on their associations with the plumbing task data record, automatically mark the plumbing task data record as complete.

Like the reference data objects discussed above, it will be appreciated that the associated of record data objects can further enhance a master schedule to provide users with better information and an improved ability to plan and manage a construction project over what existing schedule tools can provide. For instance, the computing platform 402 may cause a user's client device 104 to display a GUI view of the master schedule 406 (e.g., a Gantt chart, a lookahead schedule, etc.) that includes one or more visual indications that work for a given activity or task is complete, but that the activity or task is currently blocked from being marked as complete by something that is not displayed within the master schedule 406. The visual indication may take various forms, including a differently colored bar in the visual bar graph that represents the schedule or a notification or similar alert, as shown in the example of FIG. 5. Further, the visual indication of the missing record data object might be displayed in other ways and in other views as well, including other screens within the Schedule tool. In addition, the computing platform 402 may be configured to generate schedule alerts to notify users regarding the incomplete record data object if it is not completed within a given period of time after completion of work for the activity or task with which it is associated.

As discussed above, the associations generated by the schedule data object association engine 405 may enrich not only the activity and task data objects that are maintained in the master schedule 406, but the associated data objects as well. For example, each record data object may include a due date attribute that indicates a value for when the record data object is required to be completed. Further, it will be appreciated that the due dates for record data objects may need to be coordinated with the completion dates of the activities and tasks with which they are associated. In some implementations, the computing platform 402 may enforce by default a maximum number of days after the work for an activity or task is finished that an associated record data object can be due. When a record data object is associated with an activity or task data object at block 306, the schedule data object association engine 405 may update the value of the due date of the record data object to be within the allowable number of days after the scheduled finish date of the activity or task. Further, if a record data object was created, within another tool of the construction management software application, without a value for its due date, the schedule data object association engine 405 may assign a due date to the record data object according to its association with the activity or task data object in the master schedule 406.

Changes made to an activity or task data object may affect its associated record data objects. Similarly, a change to a record data object may affect some or all of the activity or task data objects that are associated with it. Accordingly, the computing platform 402 may cause such updates to a given data record to be dynamically applied to its associated data records. For example, a schedule activity that is pulled forward in time to start sooner than originally scheduled may involve adjusting the finish date of the corresponding schedule activity data object within the master schedule 406. This, in turn, may trigger a corresponding update to the due dates of one or more record data objects that must be completed before the activity data record can be marked as complete. In this regard, the due dates of each record data object may be updated within their own respective tool of the construction management software application, based on the change within the Schedule tool. The computing platform 402 may notify users associated with the updated record data objects, notifying them of the revised due date. Alternatively, the completion of a record data object may be delayed, requiring its due date to be pushed back in time. In a similar way, the computing platform 402 may cause this type of type—implemented in a separate tool of the construction management software application—to be propagated to the Schedule tool and the affected activity and task data records that are associated with the delayed record data object.

Another example of a type of data object within a construction management software application that may be identified using the schedule data ingestion and identification engine 403 is a location entity data object. Location entity data objects, or simply “location entities,” are data objects that represent a physical location or area within the construction project, such as a floor of a building, a room, a hallway, etc. In this regard, the construction project data stores 404 may include a hierarchical taxonomy of location entities (e.g., data objects that correspond to respective spatial locations or physical objects) associated with the construction project (e.g., a location hierarchy). The computing platform 402 may generate the hierarchical taxonomy of location entities prior to receiving the input data 401.

At a high level, the computing platform 402 may utilize one or more data science models to generate the hierarchical taxonomy of location entities associated with the construction project in the following way.

As input, the computing platform 402 may receive, in digital form, a set of one or more two-dimensional (2D) drawings for the construction project. The one or more 2D drawings may be received, for example, from an end-user device 212a (which may correspond to one of the client devices 112 shown in FIG. 1) via a communication path (which may correspond to one of the communication paths 110 shown in FIG. 1). The one or more 2D drawings may take many forms and may be stored in a variety of file formats. Some examples of forms that 2D drawings may take include architectural drawings, construction blueprints, floor plans, concept drawings, elevation drawings, electrical drawings, structural drawings, detail drawings, installation drawings, fire protection drawings, site plans, reflected ceiling plans, mechanical drawings, plumbing drawings, HVAC (Heating, Ventilation, and Air Conditioning) drawings, foundation plans, and landscape drawings, to name a few. Such drawings may be stored in formats such as portable document format (PDF), scalable vector graphics (SVG), portable network graphics (PNG), graphics interchange format (GIF), tagged image file (TIFF), and Joint Photographic Experts Group (JPEG), to name a few. Other forms and formats are also possible.

Once the one or more 2D drawings have been received, the computing platform 402 may identify one or more location entities within the 2D drawings. The function of identifying the one or more location entities may take various forms and may generally involve performing a layout analysis of the one or more 2D drawings and retrieving additional information about the one or more 2D drawings to supplement the layout analysis. The function of performing the layout analysis may take various forms.

For example, the layout analysis may comprise an area detection phase and an object detection phase. During the area detection phase, the computing platform 402 may utilize one or more image processing techniques (e.g., image segmentation techniques or unsupervised image processing models) to the one or more 2D drawings to detect areas (e.g., rooms or other location entities) depicted in the one or more 2D drawings. More information about automatically detecting areas within 2D image files can be found in U.S. Pat. No. 11,410,362 (issued on Aug. 9, 2022 and entitled “Automatic Area Detection”), which is hereby incorporated by reference in its entirety. During the object detection phase, the computing platform 402 may utilize one or more object detection techniques to produce one or more respective bounding boxes and one or more respective labels (e.g., indicating respective object types) for the one or more location entities depicted in the 2D drawings.

The layout analysis may also take other forms.

After the layout analysis has been performed, the computing platform 402 may utilize one or more information extraction techniques to retrieve additional information that may indicate whether one or more of the areas identified during the layout analysis comprise location entities.

The information extraction techniques may take various forms. For instance, as one example, the information extraction techniques may involve applying one or more Optical Character Recognition (OCR) techniques to recognize text in the one or more 2D drawings that may indicate the one or more location entities. As another example, the information extraction techniques may involve applying one or more natural language processing (NLP) techniques to text extracted from the one or more 2D drawings to recognize words, phrases, labels, dimensioning information, or other semantic information that may indicate the one or more location entities.

The information extraction techniques may also take other forms.

After the layout analysis has been performed and the information extractions techniques have been applied, the computing platform 402 may determine relationships between the one or more location entities that were identified. The function of determining relationships between the one or more location entities that were identified may take various forms. As one possibility, the function of determining relationships between the identified one or more location entities may involve determining graph data (e.g., in the form of vector embeddings or position embeddings) based on image embeddings produced via the area detection phase, bounding boxes produced via the object detection phase, and/or the one or more location entities identified via the information extraction techniques.

The function of determining relationships between the identified one or more location entities may also take other forms.

Once the relationships have been determined, the computing platform 402 may generate the hierarchical taxonomy of location entities associated with the construction project. The hierarchical taxonomy may take various forms. As one possibility, the hierarchical taxonomy may comprise a hierarchical data structure that classifies the one or more location entities based on similar characteristics. Within the hierarchical data structure (which may, for example, be an implementation of a graph), location entities may be represented by nodes and relationships may be represented by edges. Each given node may include one or more labels that identify one or more respective location types (e.g., room, unit, floor, etc.) of a given location entity the given node represents. Each given edge may be associated with one or more indicia of one or more types of relationships between the respective location entities that are represented by the two nodes that the given edge connects. For instance, as one example, an indicator associated with an edge that connects a first node that represents a location entity of type “floor” to a second node that represents a location entity of type “room” may indicate that the represented room is located on the represented floor. Note that some types of relationships between location entities may be transitive. For instance, if a given physical object is related to (e.g., located within) a given room and the given room is related to (e.g., located within) a given floor, the given physical object is also related to (e.g., located within) the given floor.

The hierarchical taxonomy may also take other forms.

More details about the creation of a hierarchical taxonomy of location entities and the forms such a taxonomy may take can be found in U.S. patent application Ser. No. 17/957,501 (filed on Sep. 30, 2022 and entitled “Computer Systems and Methods for Identifying Location Entities and Generating a Location Entity Data Taxonomy”), which is hereby incorporated by reference in its entirety.

A location entity data object may be identified and associated with an activity or task data object in various ways. As one possibility, the computing platform 402 may have previously associated the WBS segments codes of the native WBS tool in the construction management software application with location entities for the construction project, either based on manual user input, an automatic contextual-based association, or a combination of both. In this scenario, if the input data 401 includes imported WBS data created by a separate construction management software application, the schedule data ingestion and identification engine 403 may cause the imported WBS data segments to inherit the associated location entities when they are mapped to the native WBS segment codes. These associations to the location entity data objects are then maintained when the imported WBS data is used to generate the activity and task data objects that are used to create the master schedule 406.

In some implementations, the hierarchy of location entity data objects may be more granular than the activity and task data objects in the master schedule 406. For instance, a given task data record may correspond to plumbing work that is to be performed on a given floor of a building and may be associated with a location entity data record for the given floor. However, the location entity for the floor may be further subdivided into location entity data records that correspond to rooms and hallways on the floor of this building. In these situations, the computing platform 402 may associate the location entity data record for each sub-location with the task data record, such that the task data record is associated with multiple location entities. By “rolling up” each of the sub-locations to the lowest common task data record in this way, the improved technology for generating and utilizing an intelligent construction project schedule may allow users to track task completion at a more granular level. For example, a user may analyze the completion status of the plumbing task discussed above by reviewing whether the plumbing work is completed in each sub-location that is associated with the task. Other examples are also possible.

Another example of a type of data object within a construction management software application that may be identified using the schedule data ingestion and identification engine 403 is an assignee for each activity and task included in the input data 401. In this regard, an assignee data record may take the form of an account profile within the construction management software application (e.g., a company account, an individual user account, etc.) that generally corresponds to an entity that may have responsibility for completing an activity or task.

An assignee data record for a given activity or task may be identified in various ways. As one example, an assignee for a given activity or task may be identified based on WBS data associated with the activity or task, such as a WBS activity code that indicates a particular trade. For example, the “low voltage chases” task shown in FIG. 2A may be based on a WBS data segment having the “Electrical” activity code. As another example, the WBS data associated with the activity or task may include an indication of a resource type this is required to complete the activity or task, such as “Electrical Labor.” Based on either or both of these, the schedule data ingestion and identification engine 403 may identify the electrical subcontractor as the likely assignee for the “low voltage chases” task. Accordingly, the schedule data object association engine 405 may automatically associate the electrical subcontractor (i.e., the account profile corresponding to the electrical subcontractor) with the “low voltage chases” task as its assignee.

The schedule data ingestion and identification engine 403 may identify various other types of data records for associate with the activities and tasks indicated in the input data 401.

As a result of this new identification of data objects that are related to construction activities and tasks and the association of such data objects to the activities and tasks via the logical links discussed above, the master schedule for a construction project generate may be greatly improved as a planning tool. In particular, a master schedule for the construction project may include not only the current information that is traditionally provided by a construction schedule, such as an activity or task title, description, start/finish dates, and dependencies with other activities and tasks, but also dynamic links to the other types of data objects discussed above that are maintained in other tools of the construction management software application. New logical dependencies, constraints, and other relationships are created and can be automatically tracked by the construction management software application.

By enhancing the interconnectivity of schedule-related information across a construction management software application in this way, an intelligent construction project schedule as discussed herein may enable still further functionality that is not possible using existing scheduling tools. One example of such new functionality is a collaborative pull planning process.

During a typical construction project, look-ahead schedules are generally completed on a regular basis to fine tune upcoming schedule activities and tasks during a near-term time period (e.g., two weeks, four weeks, six weeks, etc.). As part of look-ahead scheduling, various construction project stakeholders (e.g., superintendents, general contractors, subcontractors for various different trades, etc.) will engage in “pull planning,” which refers to the process of analyzing the scheduled start and finish dates of various activities and tasks within the look-ahead time period to determine which activities or tasks can be pulled forward and started earlier than their originally scheduled start date. Doing so may allow the master schedule to be updated accordingly, moving subsequent activities and tasks forward and improving the timing of the project.

In practice, pull planning is a laborious process, as it requires the concurrent involvement of multiple different stakeholders who are responsible for different activities and tasks. Moreover, because typical scheduling tools do not feature the interconnectivity to the types of data objects discussed herein, the effects of each schedule adjustment may only be fully appreciated by relying on the current, real-time knowledge of each stakeholder, who have the best ability to foresee the secondary impacts a schedule adjustment might have, the best insight into resource availability, the requirement (and completeness, or lack thereof) of references that are needed to start a given activity, and so on. For this reason, pull planning remains a manual process and stakeholder participation is essential. However, on a busy construction site, it can be difficult to coordinate such planning meetings involving all of the necessary stakeholders on a regular basis.

To address these and other difficulties associated with current approaches to pull planning, the new technology discussed herein may facilitate a collaborative pull planning process. At a high level, each stakeholder involved in the collaborative pull planning process may separately prepare their own candidate schedule adjustment that pulls forward activities and tasks for which they are responsible. A computing platform may then simultaneously analyze the multiple different candidate schedule adjustments, corresponding to multiple different trades, to identify conflicts between tasks in the candidate schedule adjustments. The conflicts may be identified based on any of the various types of data object associations discussed above, many of which could not be identified if the analysis were limited to traditional schedule data alone. Thereafter, the computing platform may determine a resolution to the conflicts and then generate one or more updated candidate schedule adjustments that eliminate the conflicts. The computing platform may then update the master schedule according to the updated one or more candidate schedule adjustments.

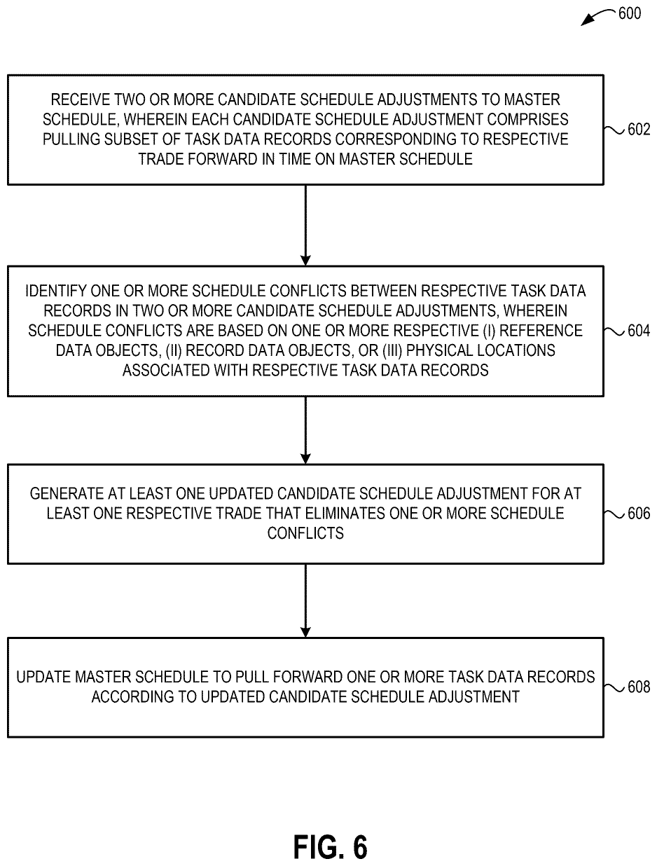

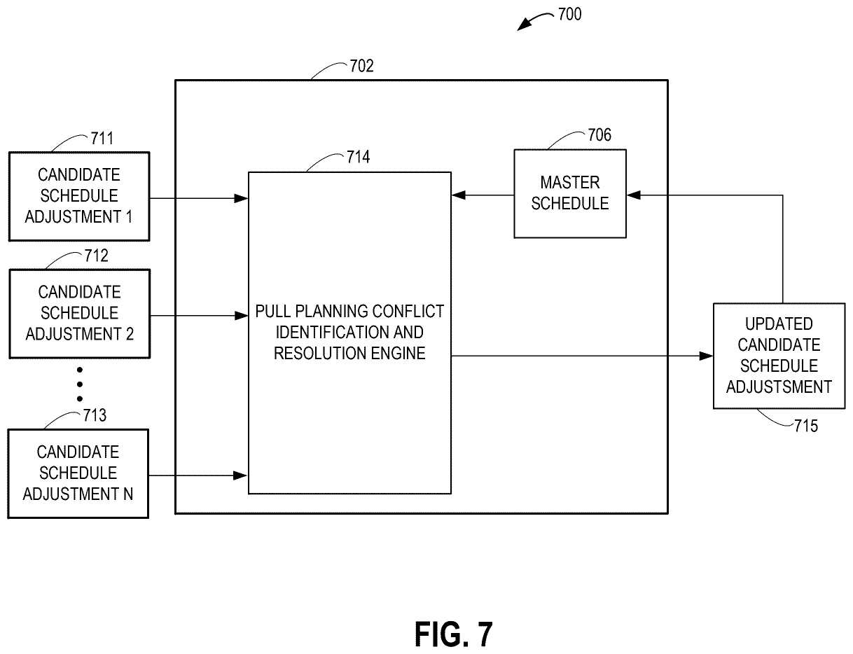

Turning to FIG. 6, example functionality is illustrated in the form of a flow diagram 600 illustrating operations that may be carried out to collaboratively update a construction project schedule. The example operations will be discussed with reference to FIG. 7, which depicts a simplified block diagram of an example data flow pipeline 700 involving a computing platform 702 that is hosting a construction management software application. In this regard, the computing platform 702 may be similar to, or the same as, the back-end computing platform 102 of FIG. 1 and the computing platform 402 of FIG. 4. However, the example functionality of FIG. 6 may be carried out by any computing platform that is capable of running the software disclosed herein. Further, it should be understood that the example functionality of FIG. 6 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular example.

As shown in FIG. 6, the example operations may begin at block 602 with the computing platform 702 receiving two or more candidate schedule adjustments to the master schedule. In this regard, the master schedule 706 shown in FIG. 7 may be similar to the master schedule 406 discussed above with respect to FIG. 4. Each of the received candidate schedule adjustments may involve pulling a subset of activity or task data objects corresponding to a respective trade forward in time on the master schedule. For example, a first candidate schedule adjustment may be received from a mechanical subcontractor that proposes to pull forward certain mechanical tasks, a second candidate schedule adjustment may be received from an electrical subcontractor that proposes to pull forward certain electrical tasks, and so on. More specifically, the

The example data flow pipeline 700 shown in FIG. 7 provides an example illustration in which a first candidate schedule adjustment 711, a second candidate schedule adjustment 712, and an n^{th} candidate schedule adjust 713 are received by the computing platform 702.

As noted above, each candidate schedule adjustment may correspond to a respective trade and may propose to pull certain activities or tasks forward in time. More specifically, the candidate schedule adjustments may propose updated start and finish dates for the activity and task data objects. As will be appreciated from the discussion above, the updated start and finish dates may correspond not only to a proposed adjustment to the activity or task, but also to the various data objects that are associated with the activity or task based on the discussion above. For example, pulling the scheduled start date for a given electrical task forward by one week may also correspond to adjusted due dates for one or more associated reference data objects and/or a record data objects, and may change the timing for when electrical work will be performed in the particular location associated with that task (e.g., as indicated by the associated location entity data object).

In view of the above, the computing platform 702 may merge each of the candidate schedule adjustments into a merged draft schedule to determine whether any conflicts exist. In this regard, the computing platform 702 may include a pull planning conflict identification and resolution engine 714, which may include one or more subsystems of the computing platform 702. The pull planning conflict identification and resolution engine 714 may be configured to analyze not only the dependencies within the merged schedule-based data, but also the dependencies and potential conflicts within the associated data objects of the merged candidate schedule adjustments.

At block 604, the computing platform 702 may identify one or more schedule conflicts between respective activity or task data objects in two or more of the candidate schedule adjustments. The identified one or more conflicts may take various forms, many of which could not be identified using traditional scheduling software tools. As a first example, a conflict may be based on the sequencing of the activities or tasks in the different candidate schedule adjustments, as dictated by the master schedule. In this regard, the master schedule 706 may serve as a reference input to the pull planning conflict identification and resolution engine 714. For instance, a first task data object and a second task data object in the master schedule 706 may have a dependency relationship. However, the merged draft schedule may pull forward the second task by more than the first task on which it depends in the master schedule, resulting in a start date for the second task that is before the finish date of the first task, thereby violating the dependency relationship. Accordingly, the pull planning conflict identification and resolution engine 714 may identify a conflict.

As another example, a conflict may be based on the availability of a particular resource that is associated with one or more activities or tasks. For instance, a particular piece of equipment (e.g., a crane), may be required for two different tasks in separate trades that are sequenced at different times in the master schedule. However, one or both of the tasks may be pulled forward such that they overlap in the merged draft schedule. As a result, the equipment cannot be used for both tasks at the same time and the pull planning conflict identification and resolution engine 714 may identify a conflict.

As another example, a conflict may be based on the status of one or more respective reference data objects and/or record data objects associated with the activities and tasks in the candidate schedule adjustments. For instance, the start date for a given task may be pulled forward to a date that is earlier than an associated reference data object can be completed, which may be a constraint set by a user. Similarly, a given task may be pulled forward such that an associated record data object cannot be completed within the default time after the task's pulled forward finish date (e.g., due to unavailability of an inspector, etc.). Although this might not prevent pulling forward the given task and starting it earlier than originally scheduled, it will delay final completion of the task and thus extend the duration of the given task. Thus, the pull planning conflict identification and resolution engine 714 may identify a conflict.

As yet another example, a conflict may be based on the physical locations associated with one or more activities or tasks in the candidate schedule adjustments. For instance, the pull planning conflict identification and resolution engine 714 may identify a location-based conflict if, as a result of pulling one or more tasks forward, two tasks associated with the same location entity data object are scheduled at the same time. This may indicate a crew conflict as laborers and equipment for two different trades may have difficulty working in the same physical location simultaneously. This type of schedule conflict may be referred to as a crew clash, or simply a clash, between two tasks.

Numerous other examples of conflicts that may be identified within the merged draft schedule are also possible.

At block 606, the computing platform 702 may generate at least one updated candidate schedule adjustment, as shown in FIG. 7 as the updated candidate schedule adjustment 715. In some embodiments, the computing platform 702 may present a list of the identified conflicts to one or more users (e.g., during a pull planning meeting), and the one or more users may propose resolutions to each conflict which are then entered manually into the construction management software application. Based on the user-entered resolutions to the identified conflicts, the computing platform 702 may generate at least one updated candidate schedule adjustment 715 that eliminates the conflicts.

Alternatively, the pull planning conflict identification and resolution engine 714 may automatically generate one or more updated candidate schedule adjustments, for at least one of the respective trades, that eliminates the one or more schedule conflicts. For example, the pull planning conflict identification and resolution engine 714 may incrementally adjust proposed start and finish dates of the activities and tasks that are the source of the conflicts until the conflicts are resolved. In this regard, the engine may follow a rules-based approach that prioritizes certain updates over others. For example, the rules-based approach for resolving identified conflicts may aim to eliminate the conflicts in a way that first maximizes the net benefit to the master schedule's critical path, followed by prioritizing tasks of a given trade that is more time-sensitive than others (e.g., due to material or labor shortages, weather, etc.) and so on. The updated candidate schedule adjustments that are automatically generated by the pull planning conflict identification and resolution engine 714 may be presented to one or more users for adjustment and/or approval.

In some situations, one or more of the schedule conflicts may involve one or more task data objects that are constrained by a reference or record data object, which may limit the possible resolutions to the conflict. For example, the pull planning conflict identification and resolution engine 714 may identify a clash between two task data objects in the candidate schedule adjustments. A first task data object involved in the clash may be associated with an incomplete reference data object that constrains how far the first task data object may be pulled forward in time. Consequently, the pull planning conflict identification and resolution engine 714 may instead determine a resolution to the clash that respects this constraint and instead adjusts the timing of the second task data object involved in the clash by moving it back in time, in an updated candidate schedule adjustment. The resolution of clashes between constrained task data objects may take various other forms as well.

At block 608, the computing platform 702 may update the master schedule 706 to pull forward one or more task data objects according to the updated candidate schedule adjustment 715. The updated master schedule 706 may then be shared with all collaborators.

Based on the discussion above, it will be appreciated that many of the types of conflicts contemplated herein could not be identified if a similar collaborative pull planning process were performed using schedule-only data associated with traditional construction schedules.

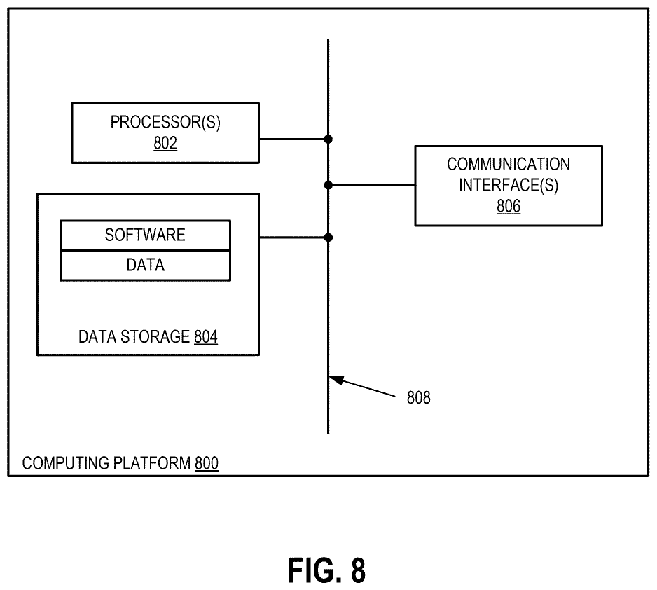

Turning now to FIG. 8, a simplified block diagram is provided to illustrate some structural components that may be included in an example computing platform 800 that may be configured to perform the platform-side functions disclosed herein. At a high level, the example computing platform 800 may generally comprise any one or more computer systems (e.g., one or more servers) that collectively include one or more processors 802, data storage 804, and one or more communication interfaces 806, each of which may be communicatively linked by a communication link 808 that may take the form of a system bus, a communication network such as a public, private, or hybrid cloud, or some other connection mechanism. Each of these components may take various forms.

For instance, the one or more processors 802 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 802 could comprise processing components that are distributed across a plurality of physical computing devices connected via a network, such as a computing cluster of a public, private, or hybrid cloud.

In turn, the data storage 804 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 804 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 8, the data storage 804 may be capable of storing both (i) program instructions that are executable by the one or more processors 802 such that the example computing platform 800 is configured to perform any of the various functions disclosed herein (including but not limited to any of the server-side functions discussed above), and (ii) data that may be received, derived, or otherwise stored by the example computing platform 800.

The one or more communication interfaces 806 may comprise one or more interfaces that facilitate communication between the example computing platform 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB (Universal Serial Bus) 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 800 may additionally have an Input/Output (I/O) interface that includes or provides connectivity to I/O components that facilitate user interaction with the example computing platform 800, such as a keyboard, a mouse, a trackpad, a display screen, a touch-sensitive interface, a stylus, a virtual-reality headset, and/or one or more speaker components, among other possibilities.

It should be understood that the example computing platform 800 is one example of a computing platform that may be used with the examples described herein. Numerous other arrangements are possible and contemplated herein. For instance, in other examples, the example computing platform 800 may include additional components not pictured and/or more or less of the pictured components.

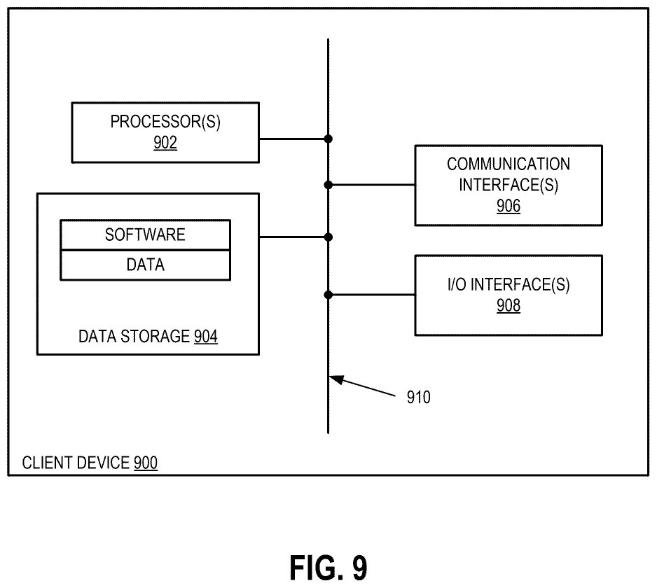

Turning next to FIG. 9, a simplified block diagram is provided to illustrate some structural components that may be included in an example client device 900 that may be configured to perform some the client-side functions disclosed herein. At a high level, the example client device 900 may include one or more processors 902, data storage 904, one or more communication interfaces 906, and an I/O interface 908, each of which may be communicatively linked by a communication link 910 that may take the form a system bus and/or some other connection mechanism. Each of these components may take various forms.

For instance, the one or more processors 902 of the example client device 900 may comprise one or more processor components, such as one or more CPUs, GPUs, ASICs, DSPs, and/or programmable logic devices such as FPGAs, among other possible types of processing components.

In turn, the data storage 904 of the example client device 900 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 9, the data storage 904 may be capable of storing both (i) program instructions that are executable by the one or more processors 902 of the example client device 900 such that the example client device 900 is configured to perform any of the various functions disclosed herein (including but not limited to any of the client-side functions discussed above), and (ii) data that may be received, derived, or otherwise stored by the example client device 900.

The one or more communication interfaces 906 may comprise one or more interfaces that facilitate communication between the example client device 900 and other systems or devices, where each such interface may be wired and/or wireless and may communicate according to any of various communication protocols. As examples, the one or more communication interfaces 906 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 908 may generally take the form of (i) one or more input interfaces that are configured to receive and/or capture information at the example client device 900 and (ii) one or more output interfaces that are configured to output information from the example client device 900 (e.g., for presentation to a given user). In this respect, the one or more input interfaces of I/O interface may include or provide connectivity to input components such as a microphone, a camera, a keyboard, a mouse, a trackpad, a touchscreen, an accelerometer, a gyroscope, a location signal receiver (e.g., a cellular signal receiver, a Wi-Fi Positioning System (WPS) receiver, a Bluetooth receiver, a Radio Frequency Identification (RFID) receiver, an Ultra-Wideband (UWB) receiver, a magnetic field receiver, a satellite signal receiver such as a GPS, etc.), and/or a stylus, among other possibilities, and the one or more output interfaces of the I/O interface 908 may include or provide connectivity to output components such as a display screen and/or an audio speaker, among other possibilities.

It should be understood that the example client device 900 is one example of a client device that may be used with the examples described herein. Numerous other arrangements are possible and contemplated herein. For instance, in other examples, the example client device 900 may include additional components not pictured and/or more or fewer of the pictured components.

Examples of the disclosed innovations have been described above. Those skilled in the art will understand, however, that changes and modifications may be made to the examples described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
a network interface;
at least one processor;
a non-transitory computer-readable medium; and
program instructions stored on the non-transitory computer-readable medium that, when executed by the at least one processor, cause the computing platform to:
receive input data indicating a set of tasks to be performed for a construction project;
for each task in the set of tasks:
identify (i) one or more reference data objects that must be complete before the task can start, (ii) one or more record data objects that must be complete before the task can be completed, and (iii) one or more physical locations within the construction project where the task will be performed; and
generate a task data object including an association with each of (i) the one or more reference data objects, (ii) the one or more record data objects, and (iii) the one or more physical locations;
maintain a master schedule for the construction project comprising each of the generated task data objects;
receive two or more candidate schedule adjustments to the master schedule, wherein each candidate schedule adjustment comprises pulling a subset of task data objects corresponding to a respective trade forward in time on the master schedule;
identify one or more schedule conflicts between respective task data objects in two or more of the candidate schedule adjustments, wherein the one or more schedule conflicts are based on one or more respective (i) reference data objects, (ii) record data objects, or (iii) physical locations associated with the respective task data objects;
generate at least one updated candidate schedule adjustment for at least one of the respective trades that eliminates the one or more schedule conflicts; and
update the master schedule to pull forward one or more task data objects according to the updated candidate schedule adjustment.

2. The computing platform of claim 1, wherein the program instructions that, when executed by the at least one processor, cause the computing platform to receive two or more candidate schedule adjustments to the master schedule comprise program instructions that, when executed by the at least one processor, cause the computing platform to:
receive, from a first client station associated with a first user, a first candidate schedule update corresponding to a first trade; and
receive, from a second client station associated with a second user, a second candidate schedule update corresponding to a second trade.

3. The computing platform of claim 1, wherein the program instructions that, when executed by the at least one processor, cause the computing platform to generate a task data object including an association with each of (i) the one or more reference data objects, (ii) the one or more record data objects, and (iii) the one or more physical locations comprise program instructions that, when executed by the at least one processor, cause the computing platform to:
generate an initial task data record; and
after generating the initial task data record, update the initial task data record to include the association with each of (i) the one or more reference data objects, (ii) the one or more record data objects, and (iii) the one or more physical locations.

4. The computing platform of claim 1, further comprising program instructions stored on the non-transitory computer-readable medium that, when executed by the at least one processor, cause the computing platform to:
after generating each task data object including an association with each of (i) the one or more reference data objects, (ii) the one or more record data objects, and (iii) the one or more physical locations, add the generated task data object to the master schedule.

5. The computing platform of claim 1, further comprising program instructions stored on the non-transitory computer-readable medium that, when executed by the at least one processor, cause the computing platform to:
determine, for a given task, that a given reference data object associated with the given task is incomplete;
based on determining that the given reference data object is incomplete, cause a visual indication of the incomplete reference data object to be displayed on a representation of the master schedule.

6. The computing platform of claim 1, further comprising program instructions stored on the non-transitory computer-readable medium that, when executed by the at least one processor, cause the computing platform to:
merge the two or more candidate schedule adjustments to the master schedule into a merged draft schedule.

7. The computing platform of claim 1, wherein a first task data object and a second task data object have a dependency relationship in the master schedule, and wherein the program instructions that, when executed by the at least one processor, cause the computing platform to identify one or more schedule conflicts between respective task data objects comprise program instructions that, when executed by the at least one processor, cause the computing platform to:
determine that the dependency relationship is violated by at least one of the candidate schedule adjustments.

8. The computing platform of claim 1, wherein the program instructions that, when executed by the at least one processor, cause the computing platform to identify one or more schedule conflicts between respective task data objects comprise program instructions that, when executed by the at least one processor, cause the computing platform to:
determine that at least one of the candidate schedule adjustments includes pulling forward a task data object associated with a given physical location to a given time period, wherein a different task data object associated with the given physical location is also scheduled for the given time period.

9. A non-transitory computer-readable medium, wherein the non-transitory computer-readable medium is provisioned with program instructions that, when executed by at least one processor, cause a computing platform to:
receive input data indicating a set of tasks to be performed for a construction project;
for each task in the set of tasks:
identify (i) one or more reference data objects that must be complete before the task can start, (ii) one or more record data objects that must be complete before the task can be completed, and (iii) one or more physical locations within the construction project where the task will be performed; and
generate a task data object including an association with each of (i) the one or more reference data objects, (ii) the one or more record data objects, and (iii) the one or more physical locations;
maintain a master schedule for the construction project comprising each of the generated task data objects;
receive two or more candidate schedule adjustments to the master schedule, wherein each candidate schedule adjustment comprises pulling a subset of task data objects corresponding to a respective trade forward in time on the master schedule;
identify one or more schedule conflicts between respective task data objects in two or more of the candidate schedule adjustments, wherein the one or more schedule conflicts are based on one or more respective (i) reference data objects, (ii) record data objects, or (iii) physical locations associated with the respective task data objects;
generate at least one updated candidate schedule adjustment for at least one of the respective trades that eliminates the one or more schedule conflicts; and
update the master schedule to pull forward one or more task data objects according to the updated candidate schedule adjustment.

10. The non-transitory computer-readable medium of claim 9, wherein the program instructions that, when executed by the at least one processor, cause the computing platform to receive two or more candidate schedule adjustments to the master schedule comprise program instructions that, when executed by the at least one processor, cause the computing platform to:
receive, from a first client station associated with a first user, a first candidate schedule update corresponding to a first trade; and
receive, from a second client station associated with a second user, a second candidate schedule update corresponding to a second trade.

11. The non-transitory computer-readable medium of claim 9, wherein the program instructions that, when executed by the at least one processor, cause the computing platform to generate a task data object including an association with each of (i) the one or more reference data objects, (ii) the one or more record data objects, and (iii) the one or more physical locations comprise program instructions that, when executed by the at least one processor, cause the computing platform to:
generate an initial task data record; and
after generating the initial task data record, update the initial task data record to include the association with each of (i) the one or more reference data objects, (ii) the one or more record data objects, and (iii) the one or more physical locations.

12. The non-transitory computer-readable medium of claim 9, wherein the non-transitory computer-readable medium is also provisioned with program instructions that, when executed by the at least one processor, cause the computing platform to:
after generating each task data object including an association with each of (i) the one or more reference data objects, (ii) the one or more record data objects, and (iii) the one or more physical locations, add the generated task data object to the master schedule.

13. The non-transitory computer-readable medium of claim 9, wherein the non-transitory computer-readable medium is also provisioned with program instructions that, when executed by the at least one processor, cause the computing platform to:
determine, for a given task, that a given reference data object associated with the given task is incomplete;
based on determining that the given reference data object is incomplete, cause a visual indication of the incomplete reference data object to be displayed on a representation of the master schedule.

14. The non-transitory computer-readable medium of claim 9, wherein the non-transitory computer-readable medium is also provisioned with program instructions that, when executed by the at least one processor, cause the computing platform to:
merge the two or more candidate schedule adjustments to the master schedule into a merged draft schedule.

15. The non-transitory computer-readable medium of claim 9, wherein a first task data object and a second task data object have a dependency relationship in the master schedule, and wherein the program instructions that, when executed by the at least one processor, cause the computing platform to identify one or more schedule conflicts between respective task data objects comprise program instructions that, when executed by the at least one processor, cause the computing platform to:
determine that the dependency relationship is violated by at least one of the candidate schedule adjustments.

16. The non-transitory computer-readable medium of claim 9, wherein the program instructions that, when executed by the at least one processor, cause the computing platform to identify one or more schedule conflicts between respective task data objects comprise program instructions that, when executed by the at least one processor, cause the computing platform to:
determine that at least one of the candidate schedule adjustments includes pulling forward a task data object associated with a given physical location to a given time period, wherein a different task data object associated with the given physical location is also scheduled for the given time period.

17. A method carried out by a computing platform, the method comprising:
receiving input data indicating a set of tasks to be performed for a construction project;
for each task in the set of tasks:
identifying (i) one or more reference data objects that must be complete before the task can start, (ii) one or more record data objects that must be complete before the task can be completed, and (iii) one or more physical locations within the construction project where the task will be performed; and
generating a task data object including an association with each of (i) the one or more reference data objects, (ii) the one or more record data objects, and (iii) the one or more physical locations;
maintaining a master schedule for the construction project comprising each of the generated task data objects;
receiving two or more candidate schedule adjustments to the master schedule, wherein each candidate schedule adjustment comprises pulling a subset of task data objects corresponding to a respective trade forward in time on the master schedule;
identifying one or more schedule conflicts between respective task data objects in two or more of the candidate schedule adjustments, wherein the one or more schedule conflicts are based on one or more respective (i) reference data objects, (ii) record data objects, or (iii) physical locations associated with the respective task data objects;
generating at least one updated candidate schedule adjustment for at least one of the respective trades that eliminates the one or more schedule conflicts; and
updating the master schedule to pull forward one or more task data objects according to the updated candidate schedule adjustment.

18. The method of claim 17, further comprising:
determining, for a given task, that a given reference data object associated with the given task is incomplete;
based on determining that the given reference data object is incomplete, causing a visual indication of the incomplete reference data object to be displayed on a representation of the master schedule.

19. The method of claim 17, wherein a first task data object and a second task data object have a dependency relationship in the master schedule, and wherein identifying one or more schedule conflicts between respective task data objects comprises:
determining that the dependency relationship is violated by at least one of the candidate schedule adjustments.

20. The method of claim 17, wherein identifying one or more schedule conflicts between respective task data objects comprises:
determining that at least one of the candidate schedule adjustments includes pulling forward a task data object associated with a given physical location to a given time period, wherein a different task data object associated with the given physical location is also scheduled for the given time period.
